(19) United States
(12) Patent Application Publication
(10) Pub. No.: US 2010/0050992 A1
(43) Pub. Date: Mar. 4, 2010

(54) VARIABLE STROKE ENGINE

(75) Inventors: Keitaro Nakanishi, Wako (JP); Akinori Maezuru, Wako (JP); Katsuya Minami, Wako (JP); Koichi Ikoma, Wako (JP); Yoshihiro Okada, Wako (JP); Masakazu Kinoshita, Wako (JP); Masanobu Takazawa, Wako (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/439,792

(22) PCT Filed: Sep. 5, 2007
(86) PCT No.: PCT/JP2007/000959

§ 371 Date: Mar. 3, 2009

(30) Foreign Application Priority Data
Sep. 11, 2006 (JP) 2006-244925
Sep. 13, 2006 (JP) 2006-247540
Sep. 15, 2006 (JP) 2006-251207

(51) Int. Cl. F02B 75/04; F01M 1/06

(52) U.S. Cl. 123/48 B; 123/196 R

(57) ABSTRACT

In a variable stroke internal combustion engine, by determining the relationships of a connecting point (D) between a first link (4) and second link (5) and a connecting point (B) between the second link (5) and a control link (12) with respect to a center (A) of a crankpin (9) to be such that ΔD<ΔB holds over an entire rotational angle of the crankshaft, where ΔD is the distance between D and A and ΔB is the distance between B and A, an adequate durability of the engine can be ensured without increasing the weight thereof.

### TECHNICAL FIELD

The present invention relates to a variable stroke internal combustion engine, and in particular to a variable stroke engine that can minimize the load acting on the control link during the expansion stroke of the engine.

### BACKGROUND OF THE INVENTION

A variable stroke engine known from Japanese Patent Laid Open Publication No. 2001-317383 comprises an upper connecting rod 4 (first link) and a lower connecting rod 7 (second link) that connect a piston 9 with a crankshaft 10, and a swing arm 8 (control link) that connects the lower connecting rod with a shaft 11 (control shaft) having an eccentric portion and supported by an engine main body, and the piston stroke can be varied by changing the connecting point between the swing arm and engine main body.

Japanese Patent Laid Open Publication No. 2001-317383 discloses a variable compression ratio mechanism in which, assuming that the X-axis is defined as extending perpendicularly to both the axial line of the reciprocating movement of the piston and the axial line of the crankshaft, the X coordinate of the point of a swing arm pivotally supported by a cylinder block is positive (negative) and the X coordinate of the axial line of the reciprocating movement of the piston is negative (positive) as the crankshaft turns in the counter clockwise direction (clockwise direction).

According to the arrangement disclosed in Japanese Patent Laid Open Publication No. 2001-317383, particularly when the piston is subjected to an explosive load during the expansion stroke, a significant load is applied to the swing arm, and this requires the connecting pin to be undesirably long and large in diameter to ensure an adequate durability of the connecting part. This causes a significant increase in the weight of the engine.

According to the structure disclosed in Japanese Patent Laid Open Publication No. 2002-21592, the link geometry is determined such that an angle defined as an angle φ between the center line of the reciprocating movement of a piston pin (cylinder axial center line) and the upper link becomes zero at a certain intermediate point as the piston moves from the top dead center to a point of maximum piston speed, and the absolute value of the angle φ becomes smaller at a point where (combustion load)×(piston speed) is maximized than at the top dead center.

When a reduction of the frictional resistance between the piston and cylinder is contemplated, it is desirable to minimize the angle between the central axial line and the upper link during the expansion stroke in which the load acting on the piston moving along the cylinder axial line is maximized, assuming that the frictional coefficient between the piston and cylinder is constant over the entire angular movement of the crankshaft with the lubrication taken into consideration.

However, the frictional coefficient between the piston and cylinder changes with the rotational angle of the crankshaft depending on the temperature and the state of lubrication (vertical sliding moment of the oil ring). Also, the lateral component of the force acting on the piston increases as the angle between the cylinder axial line and the upper link increases. Therefore, the frictional coefficient and frictional loss do not simply increase with the load acting on the piston.

If the link geometry is configured such that the angle φ remains small during the interval between the top dead center and the point of the maximum piston speed, the maximum inclination angle of the upper link φmax (absolute value) inevitably increases, and this results in an overall increase in the frictional loss.

### BRIEF SUMMARY OF THE INVENTION

In view of such problems of the prior art, a primary object of the present invention is to provide an improved variable stroke engine that ensures an adequate durability and reliability without increasing the weight of the engine.

A second object of the present invention is to provide an improved variable stroke engine that can minimize the average value of the frictional loss caused by the reciprocating movement of a piston.

According to the present invention, such objects can be at least partially accomplished by providing a variable stroke internal combustion engine comprising a first link and second link that connect a piston with a crankshaft, and a control link that connects the second link with an engine main body, a piston stroke being varied by changing a connecting point between the control link and engine main body, wherein: if a center of a crankpin is denoted with A, a central connecting point between the second link and the control link is denoted with B, a central connecting point between the first link and the second link is denoted with D, an L-axis is defined as extending in parallel with a center line of a reciprocating movement of the piston Y and passing through point A, and an X-axis is defined as extending perpendicularly to the L-axis as seen from the direction of an axial line of the crankshaft; geometry of the links is configured such that ΔD<ΔB holds over an entire rotational angle of the crankshaft where ΔD is a distance along the X-axis between point D and point A and ΔB is a distance along the X-axis between point B and point A.

According to this arrangement, because the swing angle of the second link is small as compared with the rotational angle of the crankshaft, the moment around the point A is substantially balanced over the entire rotational angle of the crankshaft. In other words, if the load acting on the point D along the direction of the L-axis is FDL, and the load acting on the point B along the direction of the L-axis is FBL, because the relationship ΔD·FDL≅ΔB·FBL holds, by configuring the link geometry such that the relationship ΔD<ΔB holds at all times, the load on the point B can be kept lower than the load acting on the point D over the entire rotational angle of the crankshaft. By thus reducing the load acting on the point B or the connecting point between the second link and the control link, the surface pressure acting on the pin at the point B can be lowered, and the length and diameter of the pin can be substantially reduced. By thus reducing the size of the part surrounding the point B, the mass of the rotating/swinging part can be reduced, and this further reduces the load acting on the point B. Therefore, the present invention is highly effective in ensuring a high reliability and durability and compact design of the variable stroke mechanism.

According to a preferred embodiment of the present invention, a lubricating oil supply passage extending from an oil passage formed in a crankshaft to a connecting point between the second link and control link is internally formed in the second link. Thereby, the supply of lubricating oil to the connecting part between the second link and control link can be facilitated. In particular, if the control link is bifurcated into two parts that interpose the second link therebetween, and a pin that is passed across the bifurcated parts pivotally supports the second link, the lubricating oil supply passage extending to a part of the second link pivotally supporting the pin, the existing oil passage arrangement of the engine can be conveniently used for the lubrication of the connecting point between the second link and control link. Also, the centrifugal force acting on the second link promotes the flow of the lubricating oil toward the part where the lubrication is required.

According to a preferred embodiment of the present invention, a connecting center point between the first link and second link at a top dead center position under a minimum compression ratio condition or a maximum displacement condition and the connecting center point between the first link and second link at the top dead center position under a maximum compression ratio condition or a minimum displacement condition are positioned on different sides of a center line of a reciprocating movement of the piston pin in a plane extending perpendicularly to the crankshaft.

Thereby, the angle φ between the center line of the reciprocating movement of a piston pin (Y-axis) and the first link can be minimized over the entire range of the reciprocating movement of the piston so that the average frictional loss owing to the reciprocating movement of the piston can be minimized.

In particular, if a distance between the center line of the reciprocating movement of the piston Y and a connecting center point between the first link and second link at the top dead center position along a direction perpendicular to the center line of the reciprocating movement of the piston Y is smaller under the maximum compression ratio condition or the minimum displacement condition than under the minimum compression ratio condition or the maximum displacement condition, because the angle φ between the center line of the reciprocating movement of a piston pin (Y-axis) and the first link is minimized under a substantially maximum compression ratio condition corresponding to a fuel economy condition, an improved fuel economy can be achieved.

If a connecting center point between the first link and second link at a top dead center position is on the center line of the reciprocating movement of the piston Y in a plane extending perpendicularly to the crankshaft under a minimum compression ratio condition or a maximum displacement condition, because the angle φ between the center line of the reciprocating movement of a piston pin (Y-axis) and the first link is substantially zero, a significant economy in fuel consumption can be achieved.

In particular, in a variable displacement engine, the angle φ between the center line of the reciprocating movement of a piston pin (Y-axis) and the first link tends to be excessive. Therefore, by using the present invention, the maximum inclination angle φmax can be kept at a relatively small value, and this significantly contributes to a reduction in the frictional loss caused by the reciprocating movement of the piston.

In a reciprocating engine, a vibratory force is generated owing to the vertical movement of pistons, and such a vibratory force cannot be entirely eliminated by using a counterweight integrally provided on the crankshaft. In Japanese Patent Laid Open Publication No. 2006-132690 is proposed a technology for reducing vibrations by using a balancer shaft that rotates in synchronism with the crankshaft. However, using a vibration control device such as a balancer shaft inevitably increases the number of component parts, weight and manufacturing cost of the engine.

According to a certain aspect of the present invention, the present invention also provides a variable stroke engine comprising a piston stroke varying mechanism including a plurality of links wherein the engine includes a plurality of cylinders, and link geometries of two of the cylinders that have pistons operating at mutually different phase relationships differ from each other. Thereby, the variable stroke engine can be configured to adequately reduce vibrations without increasing the weight of the engine.

According to this arrangement of the present invention, because the phases of the vibrations caused by the movements of the links can be shifted from one cylinder to another while the different cylinders have pistons operating in mutually different phases, it is possible to minimize the vibrations of the overall engine even without using a vibration reducing device such as a balancer shaft. Therefore, the vibrations of the engine can be reduced without increasing the number of components parts, weight and manufacturing cost of the engine, and this significantly contributes to the further weight reduction and cost reduction of the engine.

### DETAILED DESCRIPTION OF THE PREFERRED EMBODIMENTS

FIGS. 1 to 4 are simplified views of a variable compression ratio/displacement engine 1 given as an embodiment of the variable stroke engine of the present invention with an upper part thereof such as a cylinder head omitted from the drawings. A piston 3 that is slidably received in a cylinder 2 of the engine 1 is connected to a crankshaft 6 via a pair of links consisting of a first link 4 and a second link 5. The valve actuating mechanism, exhaust system and intake system of this engine may be similar to those of conventional four-stroke engines.

The crankshaft 6 is essentially identical to that of a conventional fixed compression ratio engine, and comprises a crank journal 8 (rotational center of the crankshaft 6) supported in a crankcase and a crankpin 9 which is radially offset from the crank journal 8. The second link 5 is triangular in shape, and an intermediate point (first vertex) of the second link 5 is supported by the crankpin 9 so as to be able to tilt like a seesaw. An end (the second vertex) 5a of the second link 5 is connected to a big end 4b of the first link 4, and a small end 4a of the first link 4 is connected to a piston pin 10. A counterweight is provided in association with the crankshaft 6 so as to cancel a primary rotary oscillation component of the piston movement, but is not shown in the drawings as it is not different from that of a conventional engine.

The other end (third vertex) 5b of the second link 5 is connected to a small end 12a of a control link 12 which is similar in structure to a connecting rod that connects a piston with a crankshaft in a normal engine. A big end 12b of the control link 12 is connected to an eccentric portion 13a of a control shaft 13, which is rotatably supported by the crankcase 7 and extends in parallel with the crankshaft 6, via a bearing bore 14 formed by using a bearing cap.

The control shaft 13 supports the big end 12b of the control link 12 so as to be movable in the crankcase 7 within a prescribed range (about 90 degrees in the illustrated embodiment). The rotational angle of the control shaft 13 can be continually varied and retained at a desired angle by a rotary actuator (not shown in the drawing) provided on an axial end of the control shaft 13 extending out of the crankcase 7 according to the operating condition of the engine 1.

In this engine, by rotatively actuating the control shaft 13, the position of the big end 12b of the control link 12 can be moved between the position (horizontally inward position/low compression ratio or large displacement position) illustrated in FIGS. 1 and 2 and the position (vertically downward position/high compression ratio or small displacement position) illustrated in FIGS. 3 and 4, and this causes a corresponding change in the mechanical constraint on the movement of the second link 5 or the swinging angle of the second link 5 in response to the rotation of the crankshaft 6. This causes a continuous change in the effective length of the connecting rod that connects the piston 3 with the crankshaft 6 in response to the reciprocating movement of the piston 3, and this in effect allows a change in the compression ratio or displacement of the engine to be effected as desired by suitably changing the position for supporting the control link 12 with respect to the crankcase 7 by rotatively actuating the control shaft 13.

In other words, a piston stroke varying mechanism is formed by the first link 4, second link 5, control link 12 and control shaft 13, and this enables at least one of the compression ratio and the displacement of the engine to be varied in a continuous manner.

Thus, the stroke of the piston 3 within the cylinder 2 or the positions of the top dead center and bottom dead center can be varied continuously between the one extreme state indicated by letter A in FIG. 2 and the other extreme state indicated by letter B in FIG. 4.

In the foregoing embodiment, the actuating force for moving the big end 12b or the crankcase end of the control link 12 is created by turning the control shaft 13 provide with the eccentric portion 13b, but it can also be effected by other means such as a linear hydraulic cylinder as long as it can move the crankcase end of the control link 12 as required.

In the engine 1 described above, as the combustion pressure of the fuel during the expansion stroke pushes down the piston and turns the crankshaft 6, a large tensile force acts upon the control link 12 via the second link 5 supported by the crankpin 9. Conventionally, it was necessary to use a relatively long and large-diameter connecting pin to ensure an adequate mechanical strength to the connecting part between the second link 5 and control link 12 and a relatively large-diameter control shaft was also required to ensure an adequate mechanical strength to the connecting part between he control link 12 and control shaft 13. These factors caused an undesired increase in the weight of the engine.

Therefore, in the present invention, as shown in FIG. 5, if a center of the crankpin is denoted with A, a central connecting point between the second link and the control link is denoted with B, the central connecting point between the first link 4 and the second link 5 is denoted with D, an L-axis is defined as extending in parallel with the center line of a reciprocating movement of a piston Y and passing through point A, and an X-axis is defined as extending perpendicularly to the L-axis as seen from the direction of the axial line of the crankshaft, the link geometry is configured such that ΔD<ΔB holds over the entire rotational angle of the crankshaft 6 where ΔD is the distance along the X-axis between the point D which changes in position with the rotation of the crankshaft 6 and the point A on the L-axis and ΔB is the distance along the X-axis between the point B which changes in position with the rotation of the crankshaft 6 and the point A on the L-axis. FIGS. 6 and 7 show how this relationship ΔD<ΔB is maintained at all times as the crankshaft 6 rotates.

In the structure according to the present invention described above, because the swing angle of the second link 5 is small as compared with the rotational angle of the crankshaft 6, the moment around the point A is substantially balanced over the entire rotational angle of the crankshaft 6. In other words, if the load acting on the point D along the direction of the L-axis is FDL, and the load acting on the point B along the direction of the L-axis is FBL, because the relationship ΔD·FDL≅ΔB·FBL holds, by configuring the link geometry such that the relationship ΔD<ΔB holds at all times, the load on the point B can be kept lower than the load acting on the point D over the entire rotational angle of the crankshaft 6.

By thus reducing the load acting on the point B or the connecting point between the second link 5 and the control link 12, the surface pressure acting on the pin at the point B can be lowered, and the length and diameter of the pin can be substantially reduced without any ill effect. By thus reducing the size of the part surrounding the point B, the mass of the rotating/swinging part can be reduced, and this further reduces the load acting on the point B. By thus reducing the load acting on the point B, the load acting on the control shaft 13 via the control link 12 is reduced, and this allows the diameter of the control shaft 13 to be reduced. Thereby, not only the diameter of the control shaft 13 can be reduced, but also the size and mass of the bearing for the control shaft 13 can be reduced.

Now is described an embodiment which is provided with an arrangement for supplying lubricating oil to the connecting point between the small end 12a of the control link 12 and the other end 5b of the second link 5 with reference to FIGS. 8 and 9. In this embodiment, the small end 12a of the control link 12 is bifurcated into two parts that interpose the other end of the second link 5 therebetween, and a pin 21 passed across the two bifurcated parts pivotally supports the other end 5b of the second link 5.

Further, the second link 5 is formed with a lubricating oil supply passage 23 which communicates with a lubricating oil supply passage 22 internally formed in the crankshaft 6 on the one hand, and extends from the part of the second link 5 pivotally supporting the crankpin 9 to the part of the second link 5 pivotally supporting the pin 21 on the other hand.

According to the arrangement of the present invention in which the link geometry is configured such that ΔD<ΔB holds over the entire rotational angle of the crankshaft 6, the distance between the points A and B or the distance between the part of the second link 5 pivotally supporting the crankpin 9 and the part of the second link 5 pivotally supporting the pin 21 tends to be large. However, if the lubricating oil supply passage leading to the connecting point between the second link 5 and control link 12 (point B) is branched out from the crankpin 9, the point B is subjected to a significant centrifugal force owing to the swinging movement of the second link 5, and the lubricating oil is favorably conducted to the part of the second link 5 pivotally supporting the pin 21. Thereby, the lubricating oil is favorably supplied to the connecting point between the second link 5 and control link 12.

If desired, additionally or alternatively, a similar lubricating oil supply passage may be formed internally in the control link 12, and the lubricating oil may be supplied to the connecting point between the second link 5 and control link 12 from an oil passage formed in the control shaft 13.

In this variable stroke engine, as shown in FIG. 10, suppose that the central point of connection between the first link 4 and second link 5 is indicated by letter D, the central axial line (the cylinder axial center line) of the reciprocating movement of the piston pin 10 is defined as the Y-axis, and a line extending perpendicularly both to the Y-axis and the crank journal 8 is defined as the X-axis. It is also defined that the X coordinate of the point D at the top dead center is Dx_TDC. The trajectory of the point D changes in response to a change in the compression ratio or displacement of the engine, and the link geometry is configured such that the X coordinate Dxh_TDC of the point D under the maximum compression ratio or minimum displacement condition and the X coordinate Dxl_TDC of the point D under the minimum compression ratio or maximum displacement condition are located on either side of the Y-axis. Thereby, the maximum inclination angle φmax of the first link 4 with respect to the Y-axis can be minimized, and the inclination angle φ of the first link 4 with respect to the Y-axis near the top dead center may be always minimized without regard to the change in the compression ratio or displacement of the engine. In other words, according to the present invention, over the entire range of varying the compression ratio or displacement and over the entire rotational angle of the crankshaft 6, the maximum inclination angle φmax of the first link 4 with respect to the Y-axis can be minimized, and the lateral component of the force of the piston acting on the piston pin 10 can be minimized so that the friction between the cylinder 2 and piston 3 and the resulting average frictional loss can be minimized, and the engine efficiency can be improved.

In particular, it is desirable if the link geometry is configured such that the distance EDh along the X-axis between the central point of connection Dx_TDC between the first link 4 and second link 5 at the top dead center and the central axial line of the piston pin 10 (Y-axis) under the maximum compression ratio or minimum displacement condition is smaller than the distance ED1 under the minimum compression ratio or maximum displacement condition. Thereby, the inclination angle φ of the first link 4 with respect to the axial center line of the movement of the piston pin 10 (Y-axis) can be minimized under a condition near the maximum compression ratio condition which is a fuel saving condition, and this contributes to an improved fuel mileage.

Further, it is preferable if the link geometry is configured such that the value of EDh is zero or the central point of connection Dxh_TDC between the first link 4 and second link 5 at the top dead center is located on the axial center line of the movement of the piston pin 10 (Y-axis). Thereby, the inclination angle φ of the first link 4 with respect to the axial center line of the movement of the piston pin 10 (Y-axis) can be substantially reduced to zero, and this significantly contributes to an improved fuel mileage.

In the foregoing embodiments, the actuating force for moving the big end 12b or the crankcase end of the control link 12 is created by turning the control shaft 13 provide with the eccentric portion 13b, but it can also be effected by other means such as a linear hydraulic cylinder as long as it can move the crankcase end of the control link 12 as required.

It is known that the secondary vibration can be reduced by suitably selecting the link geometry in such a multi-link type reciprocating engine. However, in case of a multi-cylinder engine, if all the cylinders are provided with a same link geometry, the phase of the vibrations caused by the movement of the links of one cylinder may coincide with that of another cylinder, and this may prevent an effective reduction in vibrations.

Therefore, according to the present invention, as shown in FIGS. 11a and 11b, in an in-line four-cylinder engine, the lengths of the various links (first link 4, second link 5 and control link 12) are varied between a first group consisting of the first and fourth cylinders and a second group consisting of the second and third cylinders so that the secondary vibration component generated by the cylinders of the first group may differ in phase from the secondary vibration component generated by the cylinders of the second group. Thereby, the vibrations caused by the first group may be canceled by the vibrations caused by the second group.

In general, in a multi-cylinder engine, it is preferable if the link geometries of two of the cylinders that have pistons operating at mutually different phase relationships differ from each other. In case of an in-line four-cylinder engine, it may be arranged such that a group consisting of the first and fourth cylinders have a first link geometry and a group consisting of the second and third cylinders have a second link geometry different from the first link geometry. In case of a V-type engine, it may be arranged such that cylinders belonging to a first cylinder bank have a first link geometry and cylinders belonging to a second cylinder hank have a second link geometry different from the first link geometry.

According to this aspect of the present invention, not only the secondary vibration component of the engine can be reduced but also the fourth-order vibration component of the engine can be reduced, and this is beneficial in a high speed engine design. The present invention can be applied to any link geometry as long as it can produce a phase difference between different cylinders that can cancel vibrations of one cylinder with those of another.

Although the present invention has been described in terms of preferred embodiments thereof, it is obvious to a person skilled in the art that various alterations and modifications are possible without departing from the scope of the present invention which is set forth in the appended claims.

The contents of the original Japanese patent applications on which the Paris Convention priority claim is made for the present application are incorporated in this application by reference.

### BRIEF DESCRIPTION OF THE DRAWINGS

Now the present invention is described in the following with reference to the appended drawings, in which:

FIG. 1 is a vertical sectional view of the internal combustion engine embodying the present invention under the minimum compression ratio or maximum displacement condition of the engine when the piston is at the top dead center;

FIG. 2 is a vertical sectional view of the internal combustion engine embodying the present invention under the minimum compression ratio or maximum displacement condition of the engine when the piston is at the bottom dead center;

FIG. 3 is a vertical sectional view of the internal combustion engine embodying the present invention under the maximum compression ratio or minimum displacement condition of the engine when the piston is at the top dead center;

FIG. 4 is a vertical sectional view of the internal combustion engine embodying the present invention under the maximum compression ratio or minimum displacement condition of the engine when the piston is at the bottom dead center;

FIG. 5 is a diagram illustrating an exemplary link geometry according to the present invention;

FIG. 6 is a graph showing the relationship between the rotational angle of the crankshaft and movements of the various links;

FIG. 7 is a graph showing the changes in ΔD and ΔB with the rotational angle of the crankshaft;

FIG. 8 is an enlarged fragmentary view showing the connecting part between the second link and control link;

FIG. 9 is a sectional view taken along line IX-IX of FIG. 8;

FIG. 10 is a diagram illustrating the movement of the various links with the change in the rotational angle of the crankshaft under the maximum compression ratio or minimum displacement condition and the minimum compression ratio or maximum displacement condition;

FIGS. 11a is a conceptual diagram illustrating a link geometry used for a certain group of cylinders in an in-line four-cylinder engine; and

FIG. 11b is a conceptual diagram illustrating a different link geometry used for another group of cylinders in the same engine as that in FIG. 11a.

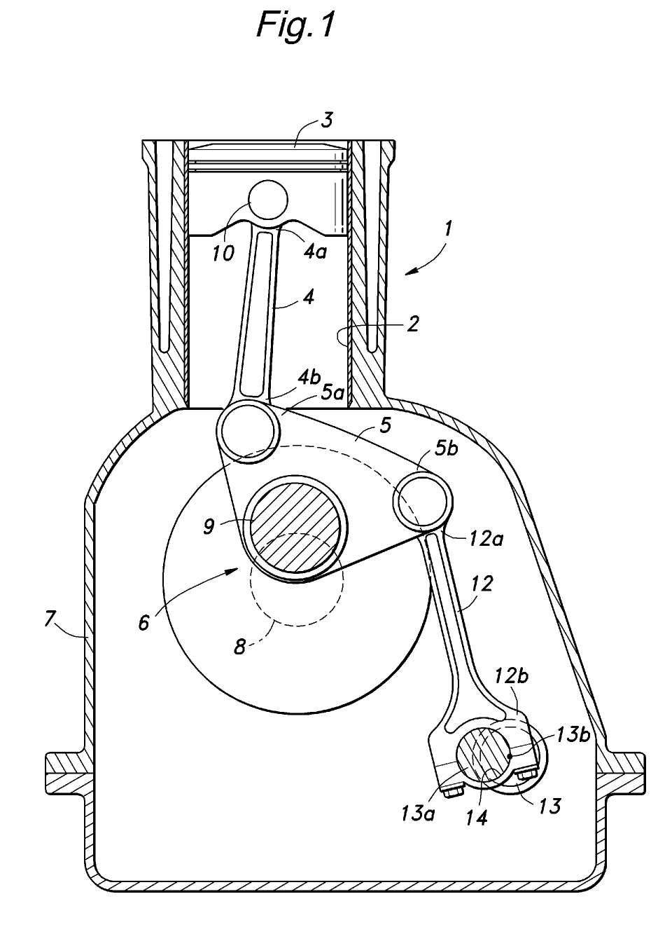

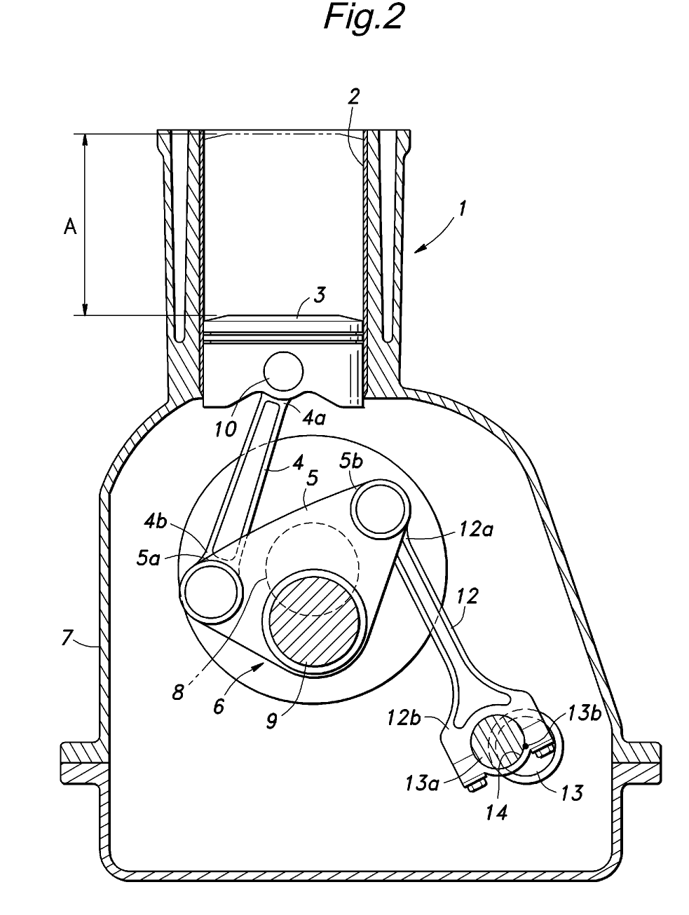

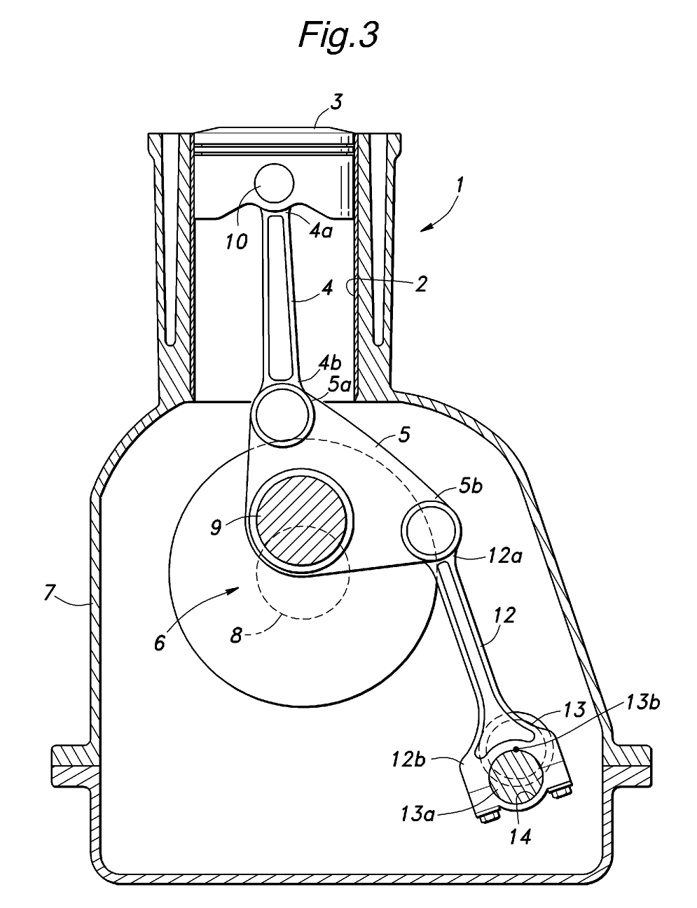

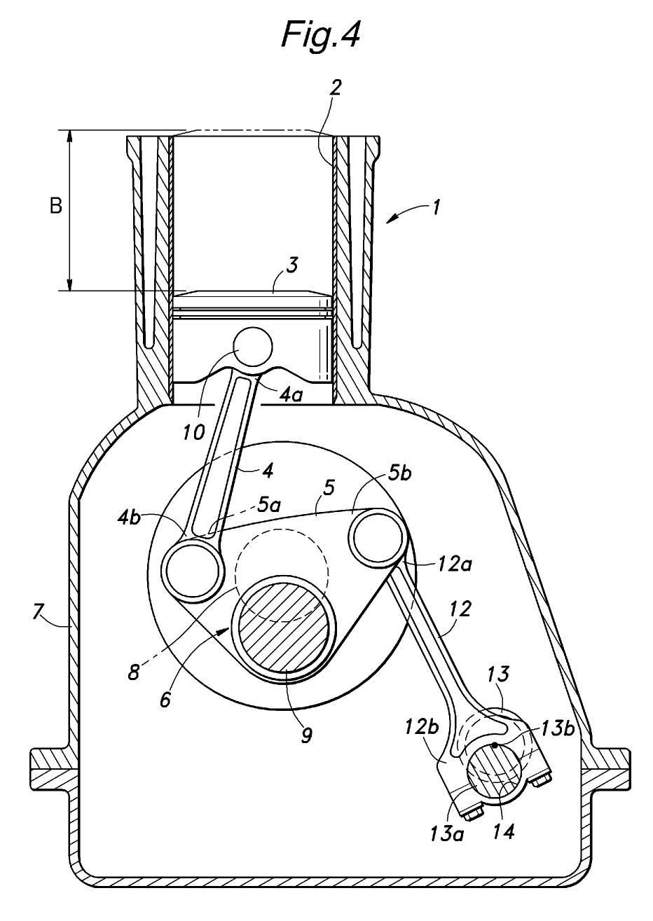

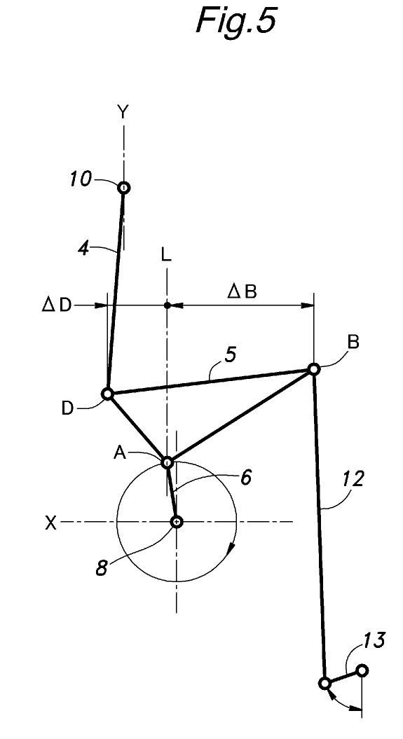

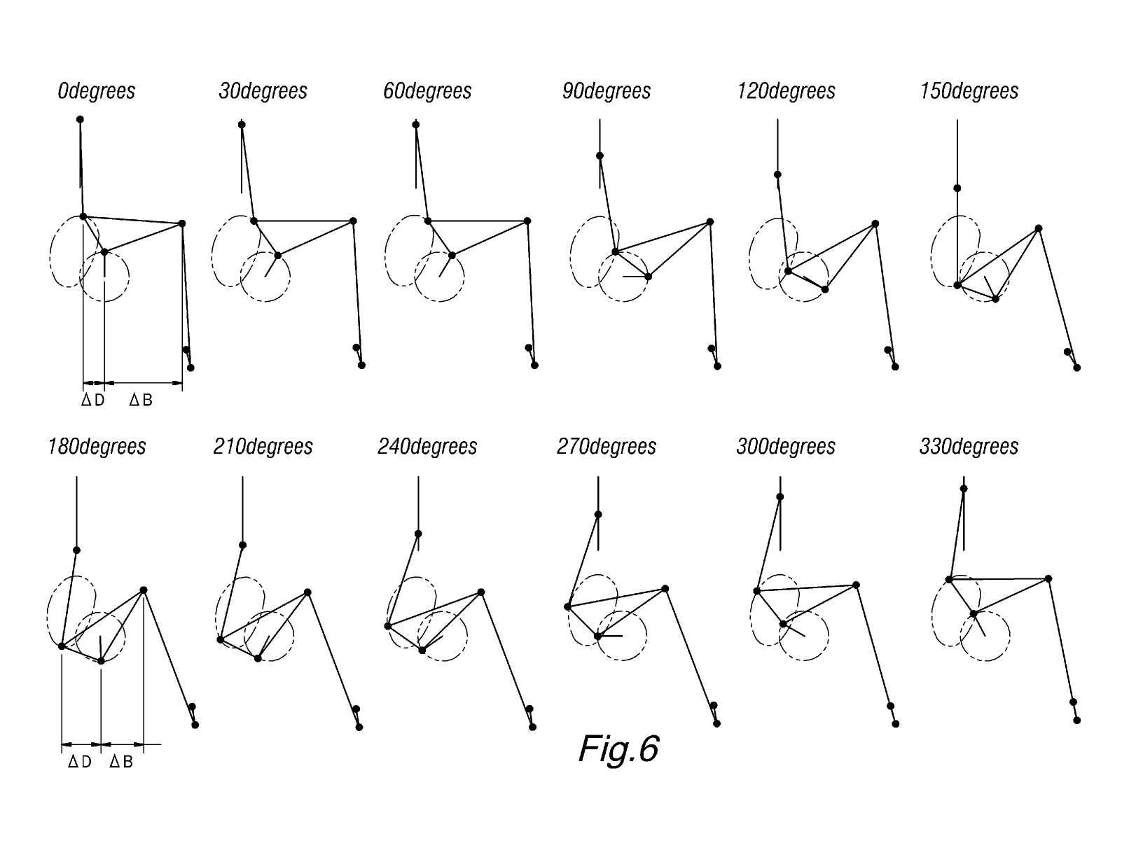

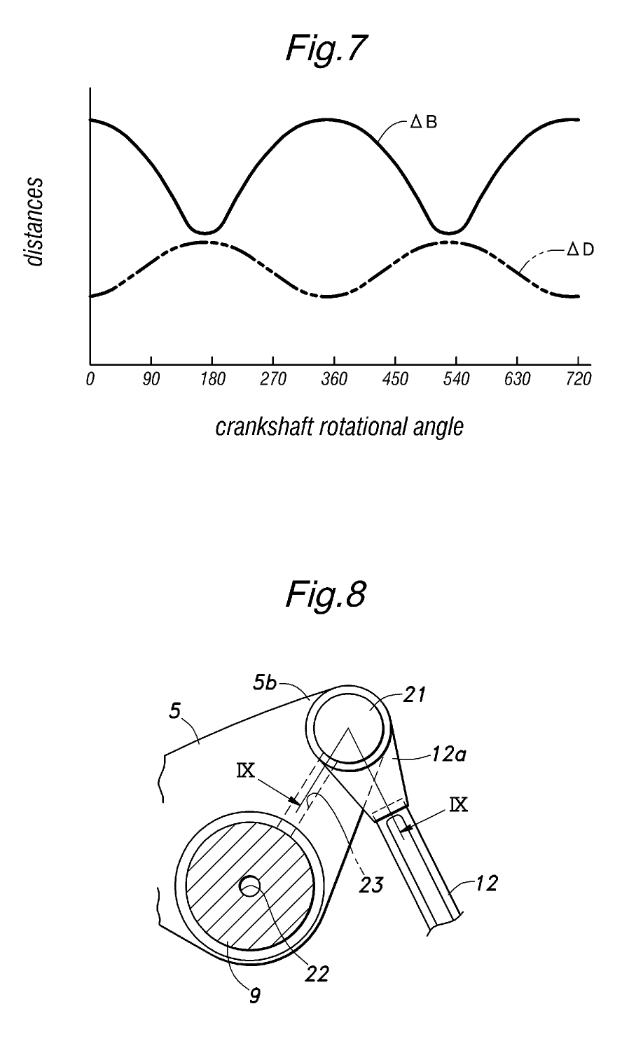

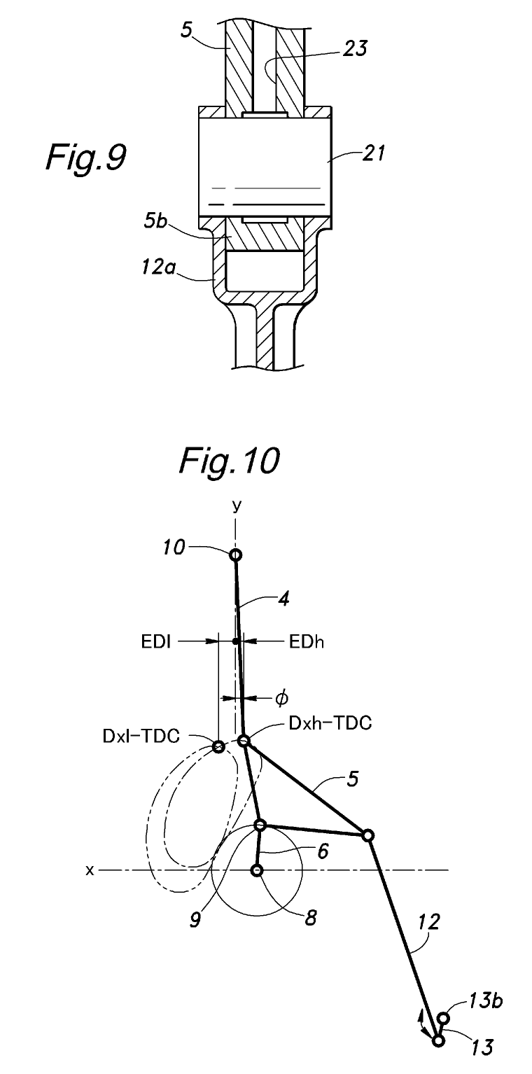

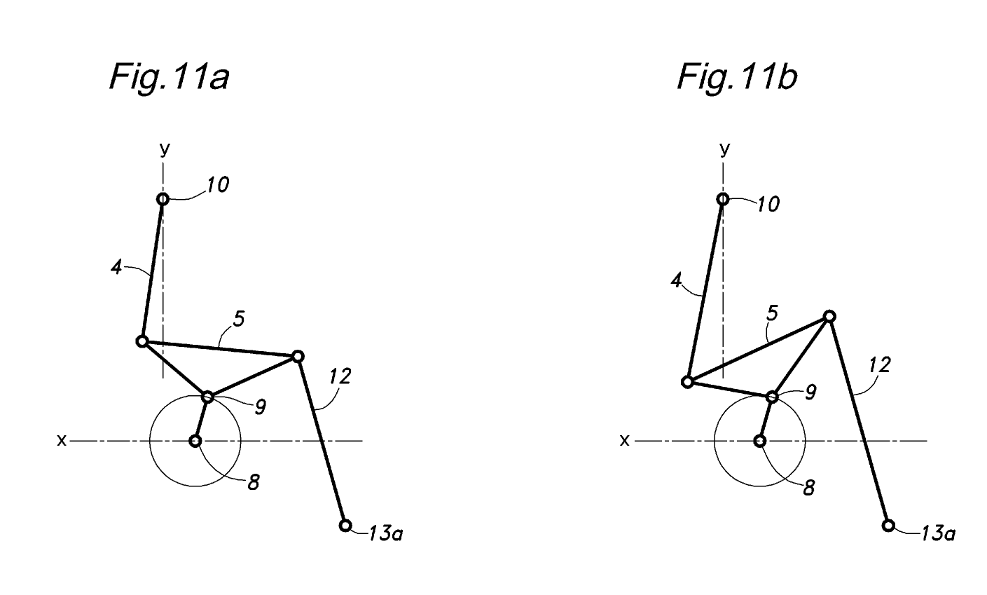

1. A variable stroke internal combustion engine comprising a first link and second link that connect a piston with a crankshaft, and a control link that connects the second link with an engine main body, a piston stroke being varied by changing a connecting point between the control link and engine main body, wherein:
if a center of a crankpin is denoted with A, a central connecting point between the second link and the control link is denoted with B, a central connecting point between the first link and the second link is denoted with D, an L-axis is defined as extending in parallel with a center line of a reciprocating movement of the piston Y and passing through point A, and an X-axis is defined as extending perpendicularly to the L-axis as seen from the direction of an axial line of the crankshaft;
geometry of the links is configured such that ΔD<ΔB holds over an entire rotational angle of the crankshaft where ΔD is a distance along the X-axis between point D and point A and ΔB is a distance along the X-axis between point B and point A.

2. The variable stroke internal combustion engine according to claim 1, wherein a lubricating oil supply passage extending from an oil passage formed in a crankshaft to a connecting point between the second link and control link is internally formed in the second link.

3. The variable stroke internal combustion engine according to claim 2, wherein the control link is bifurcated into two parts that interpose the second link therebetween, and a pin that is passed across the bifurcated parts pivotally supports the second link, the lubricating oil supply passage extending to a part of the second link pivotally supporting the pin.

4. The variable stroke internal combustion engine according to claim 1, wherein a connecting center point between the first link and second link at a top dead center position under a minimum compression ratio condition or a maximum displacement condition and the connecting center point between the first link and second link at the top dead center position under a maximum compression ratio condition or a minimum displacement condition are positioned on different sides of a center line of a reciprocating movement of the piston pin in a plane extending perpendicularly to the crankshaft.

5. The variable stroke engine according to claim 4, wherein a distance between the center line of the reciprocating movement of the piston Y and a connecting center point between the first link and second link at the top dead center position along a direction perpendicular to the center line of the reciprocating movement of the piston Y is smaller under the maximum compression ratio condition or the minimum displacement condition than under the minimum compression ratio condition or the maximum displacement condition.

6. The variable stroke engine according to claim 1, wherein a connecting center point between the first link and second link at a top dead center position is on the center line of the reciprocating movement of the piston Y in a plane extending perpendicularly to the crankshaft under a minimum compression ratio condition or a maximum displacement condition.
